(19) United States
(12) Patent Application Publication
(10) Pub. No.: US 2020/0041750 A1
(43) Pub. Date: Feb. 6, 2020

(54) LIGHT SHADING PLATE AND LENS MODULE INCLUDING THE SAME

(71) Applicant: AAC Technologies Pte. Ltd., Singapore city (SG)

(72) Inventor: Hailong Wang, Shenzhen (CN)

(21) Appl. No.: 16/528,664

(22) Filed: Aug. 1, 2019

(30) Foreign Application Priority Data
Aug. 6, 2018 (CN) 201821262983.6

(51) Int. Cl. G02B 7/02; G02B 13/00; H04N 5/225

(52) U.S. Cl. CPC G02B 7/021; H04N 5/2254; G02B 7/022; G02B 13/002

(57) ABSTRACT

The present disclosure relate to the field of optical imaging technologies, and provides a light shading plate and a lens module including the same. The light shading plate includes: a body for fixedly shading light; and a light shading arm for shading light. The body includes an object-side surface close to an object side, an image side surface opposite to the object-side surface, and an inner peripheral surface connecting the object-side surface with the image-side surface and being close to an optical axis. The light shading arm extends from the inner peripheral surface in a direction facing towards an optical axis. The light shading plate and the lens module including the light shading plate provided by the present disclosure can prevent stray light and light leakage, reduce production cost, and improve optical performance and stability of the lens module.

### TECHNICAL FIELD

The present disclosure relate to the field of optical imaging technologies, and in particular, to a light shading plate and a lens module including the same.

### BACKGROUND

With the continuous development of technology, electronic devices become more and more intelligent. In addition to digital cameras, portable electronic devices such as tablet PC and mobile phones are also equipped with lens modules having a photographing function in order to meet the users' requirements to take photos at any time. In the related art, a lens module includes a lens and a light shading plate for blocking light.

The inventors have found that at least the following problems exist in the related art. In order to prevent stray light and light leakage, a light shading piece is assembled on a light shading plate. The arrangement of the light shading piece increases the process of assembling the light shading piece, thereby increasing the production cost. Furthermore, the light shading piece is liable to generate burrs during a process of assembling the light shading piece to the light shading plate, and the light shading piece and the light shading plate are easily assembled to be deviated, which affects the optical performance of the lens. Meanwhile, the light shading piece and the light shading plate may be displaced during the use, thereby resulting in a low stability of the lens module.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional schematic structural of showing a light shading plate according to a first embodiment of the present disclosure;

FIG. 2 is a partial enlarged view of a portion A shown in FIG. 1;

FIG. 3 is a cross-sectional schematic structural view of a light shading plate according to an alternative embodiment of the present disclosure;

FIG. 4 is a partial enlarged view of a portion B shown in FIG. 3;

FIG. 5 is a cross-sectional schematic structural view of a lens module according to a second embodiment of the present disclosure; and

FIG. 6 is a cross-sectional schematic structural view of a lens module according to an alternative embodiment of the present disclosure.

### DESCRIPTION OF EMBODIMENTS

The present disclosure will be further illustrated with reference to the accompanying drawings and the embodiments.

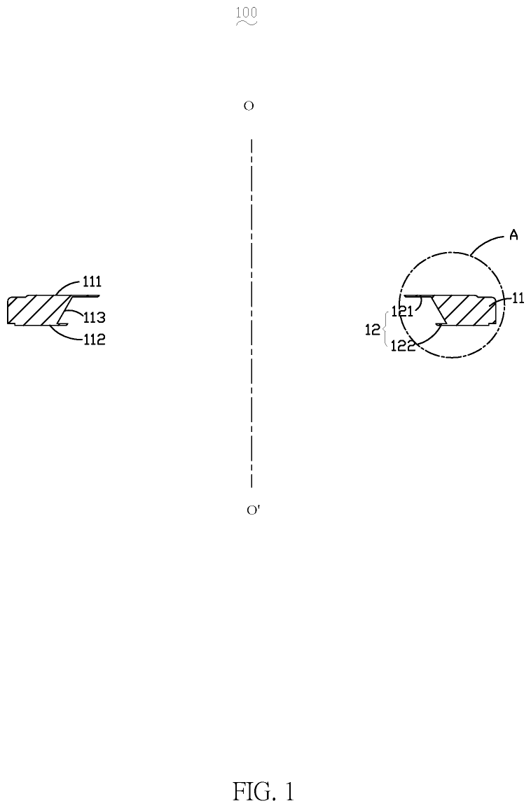

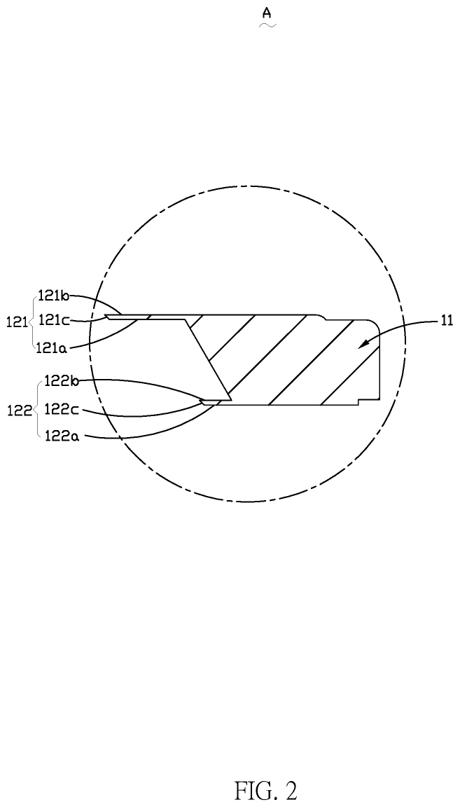

In order to solve the above technical problems, the present disclosure provides a light shading plate 100. As shown in FIGS. 1 and 2, the light shading plate 100 includes a body 11 configured to abut against and hold a lens, and a light shading arm 12 for shading light. The body 11 includes an object-side surface 111 close to the object side, an image-side surface 112 opposite to the object-side surface 111, and an inner peripheral surface 113 connecting the object-side surface 111 with the image-side surface 112 and close to an optical axis OO′. The light shading arm 12 extends from the inner peripheral surface 113 in a direction facing towards the optical axis OO′.

Compared with the related art, the present embodiment provides the light shading arm 12 for shading light on the body 11, thereby preventing stray light and light leakage without additionally adding a light shading piece. This can reduce cost and also avoid the problem of the light shading piece being deviated during the assembling and the generating of the burr, thereby improving the optical performance of the lens module. Meanwhile, the displacement problem of the light shading piece and the light shading plate 100 during the use can be avoided, thereby improving the stability of the lens module.

In this embodiment, the light shading arm 12 includes a first light shading arm 121 and a second light shading arm 122. The first light shading arm 121 is provided at an edge of the inner peripheral surface 113 close to the object-side surface 111. The second light shading arm 122 is provided at an edge of the inner peripheral surface 113 close to the image-side surface 112. By providing the first light shading arm 121 closer to the lens, it can better prevent stray light from entering the lens. By providing the second light shading arm 122 closer to an opening of the lens barrel, it can better prevent stray light from entering the lens barrel, thereby improving the optical performance of the lens module.

It can be understood that the first light shading arm 121 and/or the second light shading arm 122 can also be provided at a middle position of the inner peripheral surface 113 as long as the effect of preventing stray light and light leakage can be achieved.

Optionally, the first light shading arm 121 includes a first surface 121a close to the image side, a second surface 121b opposite to the first surface 121a, and a first end surface 121c extending obliquely from a side of the second surface 121b close to the optical axis OO′ to the first surface 121a along a direction facing away from the optical axis OO′. The second light shading arm 122 includes a third surface 122a close to the image side, a fourth surface 122b opposite to the third surface 122a, and a second end surface 122c extending obliquely from a side of the fourth surface 122b close to the optical axis OO′ to the third surface 122a along a direction facing away from the optical axis OO′. A distance between the first end surface 121c and the optical axis OO′ is smaller than a distance between the second end surface 122c and the optical axis OO′. Since the light passing through the through hole of the light shading plate 100 is divergent, setting the distance between the first end surface 121c and the optical axis OO′ to be smaller than the distance between the second end surface 122c and the optical axis OO′ is more in line with an imaging rule of the lens module and can retain more light for imaging as much as possible, thereby improving the imaging quality of the lens module.

It should be noted that an extinction area is provided on the first surface 121a. Since the distance between the first end surface 121c and the optical axis OO′ is smaller than the distance between the second end surface 122c and the optical axis OO′, more stray light is reflected to the first surface 121a. Therefore, it can greatly prevent stray light from entering the lens by providing an extinction area on the first surface 121a.

In this embodiment, the first end surface 121c is provided with an extinction area. In this way, the stray light incident on the first end surface 121c can be better absorbed, so that stray light can be better prevented. Optionally, the second end surface 122c is provided with an extinction area. In this way, the stray light incident on the second end surface 122c can be better absorbed, so that stray light can be better prevented.

It can be understood that the first end surface 121c and/or the second end surface 122c may also extend along the optical axis OO′, and other surfaces of the first light shading arm 121 and the second light shading arm 122 can also be provided with the extinction area.

Optionally, the light shading arm and the body are formed into one piece. In this way, the body and the light shading arm can be simultaneously formed in one operation, which saves the manufacturing process, thereby saving production cost.

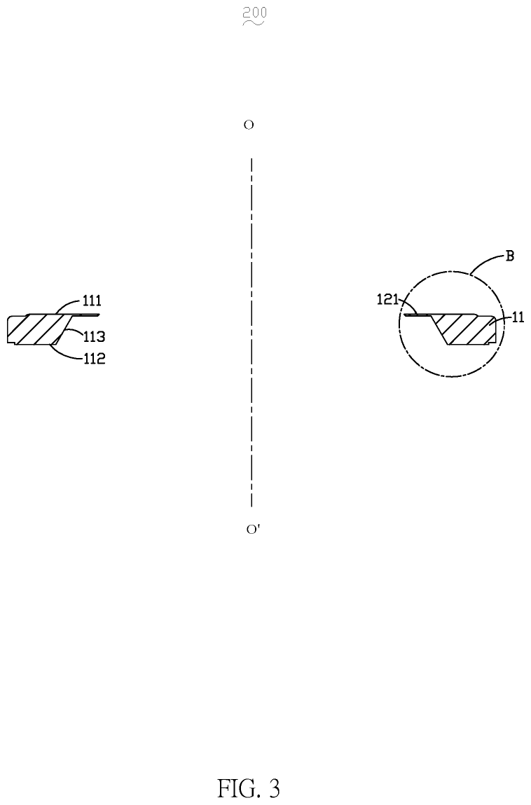

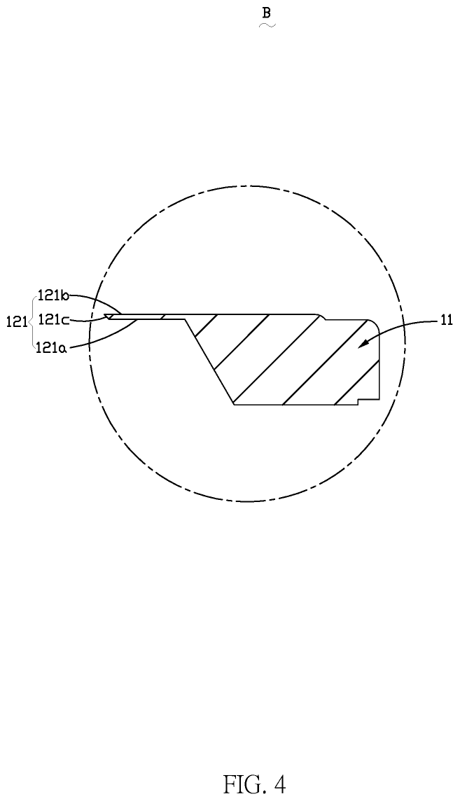

As shown in FIGS. 3 and 4, the light shading arm may also include only the first light shading arm 121. The first light shading arm 121 is provided on an edge of the inner peripheral surface 113 close to the object-side surface 111.

It can be understood that the first light shading arm 121 can also be provided at a middle position of the inner peripheral surface 113, and the number of the light shading arms 12 can also be three or more, which can achieve the same technical effect and will not be elaborated herein.

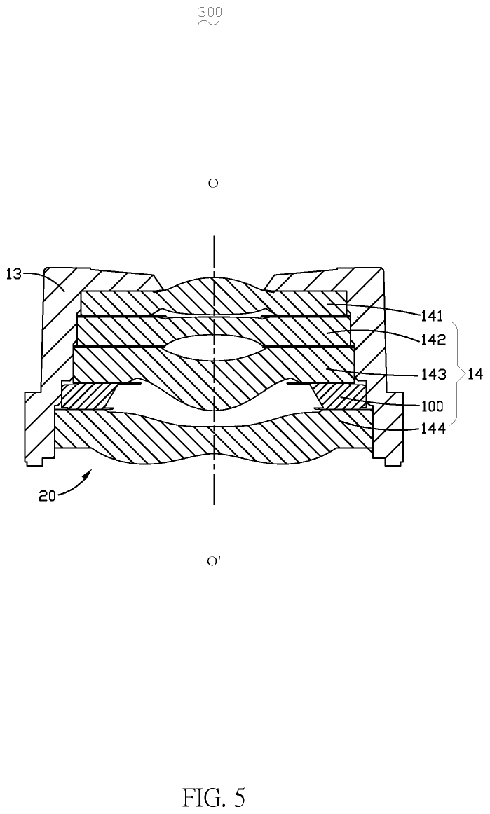

A second embodiment of the present disclosure provides a lens module 300. As shown in FIG. 5, the lens module 300 includes a lens barrel 13 having a receiving space 20, and an optical assembly 14 received in the receiving space 20. The optical assembly 14 includes a first lens 141 close to the object side, a second lens 142 provided at the image side of the first lens 141, a third lens 143 provided at the image side of the second lens 142, a fourth lens 144 provided at the image side of the third lens 143, and the above-described light shading plate 100 provided between the third lens 143 and the fourth lens 144.

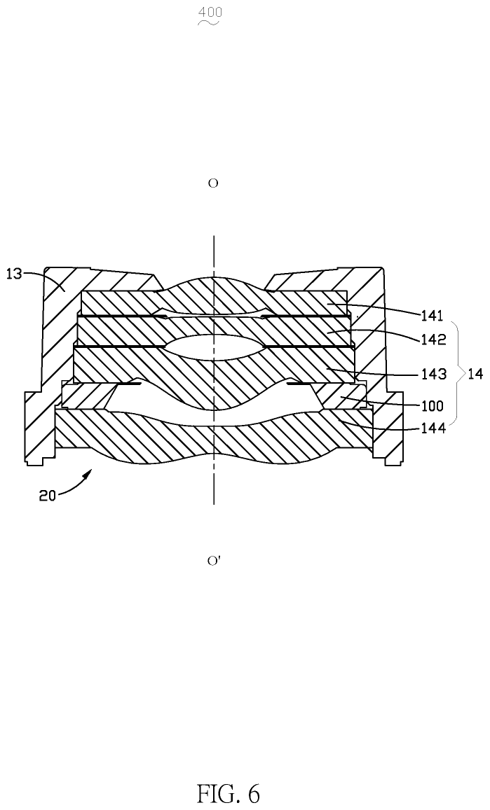

It can be understood that, as shown in FIG. 6, the lens module 400 can also include the above-mentioned light shading plate 200. In one embodiment, the lens module 400 includes a lens barrel 13 having a receiving space 20, and an optical assembly 14 received in the receiving space 20. The optical assembly 14 includes a first lens 141 close to the object side, a second lens 142 provided at the image side of the first lens 141, a third lens 143 provided at the image side of the second lens 142, a fourth lens 144 provided at the image side of the third lens 143, and the above-described light shading plate 200 provided between the third lens 143 and the fourth lens 144.

The above are only preferred embodiments of the present disclosure. Here, it should be noted that those skilled in the art can make modifications without departing from the inventive concept of the present disclosure, but these shall fall into the protection scope of the present disclosure.

What is claimed is:

1. A light shading plate, comprising:
a body for fixedly shading light; and
a light shading arm for shading light,
wherein the body comprises an object-side surface close to an object side, an image side surface opposite to the object-side surface, and an inner peripheral surface connecting the object-side surface with the image-side surface and being close to an optical axis; and the light shading arm extends from the inner peripheral surface in a direction facing towards an optical axis.

2. The light shading plate as described in claim 1, wherein the light shading arm comprises a first light shading arm and a second light shading arm; the first light shading arm is provided on an edge of the inner peripheral surface close to the object-side surface; and the second light shading arm is provided on an edge of the inner peripheral surface close to the image-side surface.

3. The light shading plate as described in claim 2, wherein the first light shading arm comprises a first surface close to the image side, a second surface opposite to the first surface, and a first end surface extending obliquely from a side of the second surface close to the optical axis to the first surface along a direction facing away from the optical axis; the second light shading arm comprises a third surface close to the image side, a fourth surface opposite to the third surface, and a second end surface extending obliquely from a side of the fourth surface close to the optical axis to the third surface along a direction facing away from the optical axis; and a distance between the first end surface and the optical axis is smaller than a distance between the second end surface and the optical axis.

4. The light shading plate as described in claim 3, wherein the first surface is provided with an extinction area.

5. The light shading plate as described in claim 4, wherein the first end surface is provided with an extinction area.

6. The light shading plate as described in claim 5, wherein the second end surface is provided with an extinction area.

7. The light shading plate as described in claim 1, wherein the light shading arm and the body are formed into one piece.

8. A lens module, comprising:
a lens barrel having a receiving space; and
an optical assembly received in the receiving space,
wherein the optical assembly comprises a first lens close to an object side, a second lens provided at an image side of the first lens, a third lens provided at an image side of the second lens, a fourth lens provided at an image side of the third lens, and the shading plate as described in claim 1, and the light shading plate is provided between the third lens and the fourth lens.

9. The lens module as described in claim 8, wherein the light shading arm comprises a first light shading arm and a second light shading arm; the first light shading arm is provided on an edge of the inner peripheral surface close to the object-side surface; and the second light shading arm is provided on an edge of the inner peripheral surface close to the image-side surface.

10. The lens module as described in claim 9, wherein the first light shading arm comprises a first surface close to the image side, a second surface opposite to the first surface, and a first end surface extending obliquely from a side of the second surface close to the optical axis to the first surface along a direction facing away from the optical axis; the second light shading arm comprises a third surface close to the image side, a fourth surface opposite to the third surface, and a second end surface extending obliquely from a side of the fourth surface close to the optical axis to the third surface along a direction facing away from the optical axis; and a distance between the first end surface and the optical axis is smaller than a distance between the second end surface and the optical axis.

11. The lens module as described in claim 10, wherein the first surface is provided with an extinction area.

12. The lens module as described in claim 11, wherein the first end surface is provided with an extinction area.

13. The lens module as described in claim 12, wherein the second end surface is provided with an extinction area.

14. The lens module as described in claim 8, wherein the light shading arm and the body are formed into one piece.
